(19) United States
(12) Patent Application Publication
(10) Pub. No.: US 2012/0243723 A1
(43) Pub. Date: Sep. 27, 2012

(54) EARPHONE WITH A SUPPORT ELEMENT

(75) Inventors: Teemu HALKOSAARI, Espoo (FI); Jukka KORTESOJA, Espoo (FI)

(73) Assignee: SAVOX COMMUNICATIONS OY AB (LTD), Espoo (FI)

(21) Appl. No.: 13/071,662

(22) Filed: Mar. 25, 2011

(51) Int. Cl. H04R 1/10

(52) U.S. Cl. 381/379

(57) ABSTRACT

An earphone including a mounting element for mounting the earphone to an auricle is provided. The mounting element is attachable to a body of the earphone. The earphone further includes an adjusting element for adjusting the position of the mounting element with respect to the body of the earphone. A mounting element for mounting the earphone to an auricle is provided. The mounting element is attachable to a body of an earphone, and the mounting element includes an adjusting element for adjusting the position of the mounting element with respect to the body of the earphone.

### TECHNICAL FIELD

The invention is related to earphones, in particular to earpieces that that may be mounted in or in the immediate vicinity of a concha of an ear, and a support element comprised therein.

### BACKGROUND

Headphones that may be mounted in a concha of an ear of a user, referred to as earphones in the following, are typically used with mobile devices, such as MP3 players, audio players, mobile phones or other devices, especially portable devices, that may be used for providing audio output to a user. Such earphones are typically small in size and light in weight, and therefore especially well suitable to be carried around and used together with a mobile device, even when exercising or performing other activities involving the user wearing the earphones moving intensively. Known earphones of this type may be placed in a concha of an ear and secured therein due to their design following the shape of the concha and/or due to a transducer unit of the earphone partially entering the ear canal. However, such earphones may have challenges in secure mounting especially in use conditions involving the user moving intensively.

The objective of the invention is to provide an arrangement for an earphone that provides improved mounting in the user's ear compared to the known earphones hence enabling e.g. improved comfort of use and improved perceived audio quality due to secure mounting in the user's ear across different usage scenarios of the earphone. A further objective of the invention is to enable a versatile use of the earphone and its mounting.

### SUMMARY OF THE INVENTION

According to a first aspect of the invention, an earphone comprising a mounting element for mounting the earphone to an auricle is provided. The mounting element is attachable to a body of the earphone. The earphone further comprises an adjusting element for adjusting the position of the mounting element with respect to the body of the earphone.

According to a second aspect of the invention, a mounting element for mounting the earphone to an auricle is provided. The mounting element is attachable to a body of an earphone, and the mounting element comprises an adjusting element for adjusting the position of the mounting element with respect to the body of the earphone.

The mounting element may further comprise a sensor for measuring characteristic of human tissue for determining one or more physiological parameters.

An earphone or a mounting element according to an embodiment of the invention enables versatile use of the headphone due to adjustable but yet secure mounting to the user's ear, thus enabling high comfort of use and uncompromised audio reproduction across different usage scenarios. Moreover, an earphone or a mounting element in accordance with an embodiment of the invention may comprise a sensor measuring characteristics of the human tissue in high accuracy and reliability due to adjustable position of the mounting element with respect to the body of the earphone.

The exemplary embodiments of the invention presented in this patent application are not to be interpreted to pose limitations to the applicability of the appended claims. The verb “to comprise” is used in this patent application as an open limitation that does not exclude the existence of also unrecited features. The features described hereinafter are mutually freely combinable unless explicitly stated otherwise.

The novel features which are considered as characteristic of the invention are set forth in particular in the appended claims. The invention itself, however, both as to its construction and its method of operation, together with additional objects and advantages thereof, will be best understood from the following detailed description of specific embodiments when read in connection with the accompanying drawings.

### BRIEF DESCRIPTION OF THE FIGURES

FIG. 1 illustrates a schematic example of a known earphone.

FIG. 2a illustrates a schematic example of a “frontal view” of an earphone according to an embodiment of the invention.

FIG. 2b illustrates a schematic example of a “side view” of an earphone according to an embodiment of the invention.

FIG. 3a illustrates a first schematic example of an adjusting element according to an embodiment of the invention.

FIG. 3b illustrates a second schematic example of an adjusting element according to an embodiment of the invention.

FIG. 4 illustrates a schematic example of a fitting arrangement according to an embodiment of the invention.

FIG. 5a illustrates a first schematic example of a mounting element comprising a deformable portion in accordance with an embodiment of the invention.

FIG. 5b illustrates a second schematic example of a mounting element comprising a deformable portion in accordance with an embodiment of the invention.

FIG. 6a illustrates a first schematic example of a mounting element comprising a sensor for measuring characteristics of human tissue according to an embodiment of the invention.

FIG. 6b illustrates a second schematic example of a mounting element comprising a sensor for measuring characteristics of human tissue according to an embodiment of the invention.

### DETAILED DESCRIPTION

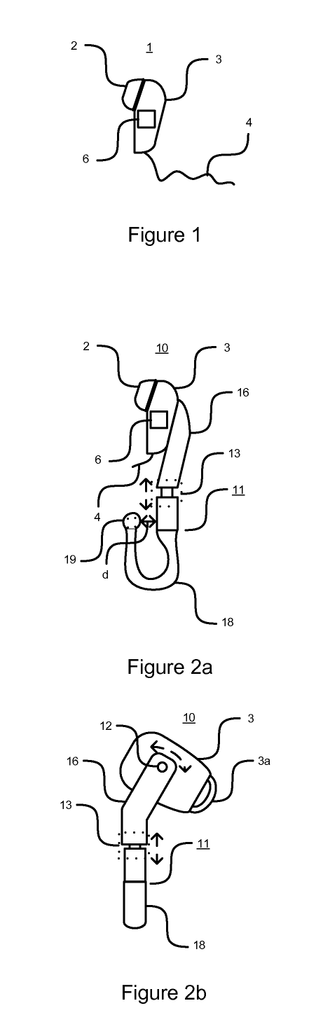

FIG. 1 illustrates a schematic example of a known earphone 1, comprising a transducer 2 attached to a body 3 of the earphone, and means for receiving 4 an audio input signal, such as a wire or wires coupled to an audio signal source. The means for receiving an audio input signal may also comprise a wireless receiver arranged to receive an audio input signal from an audio source. The earphone further comprises a control unit 6, e.g. in form of control electronics (within the body), for driving the transducer 2 in order to reproduce the received audio input signal. The control unit 6 may also be arranged to control possible other capabilities of the earphone, including (but not being limited to) exchanging (other) information e.g. via the wire(s) or a wireless communication link.

The body 3 is typically designed such that the shape of its outer perimeter provides a fit with a concha of an ear for mounting the earphone 10 in the user's ear. The body 3 mounted to the concha of the user's ear may be considered as the first support point for mounting the earphone 10. Due to each concha having an individual shape, hence making it virtually impossible to provide an essentially rigid body 3 providing a good fit for all users, the outer perimeter of the body 3 may be provided with a fitting portion 3a comprising (relatively) soft flexible material that enables a press-fit to improve mounting of the body 3 in the concha. The fitting portion 3a may cover the outer perimeter of the body 3 as a whole or in part.

FIGS. 2a and 2b illustrates a schematic example of an earphone 10 according to an embodiment of the invention. In addition of the elements of the known earphone 1, the earphone 10 according to an embodiment of the invention comprises a mounting element 11 for mounting the earphone to an auricle. A point of contact between the mounting element 11 and the auricle may be considered as a second support point for mounting the earphone 10. The mounting element 11 is attachable to the body 3. In other words, the earphone 10 comprises an attachment between the mounting element 11 and the body 3. The earphone 10 further comprises one or more adjusting elements 12, 13 for adjusting the position of the mounting element 11 with respect to the body 3 of the earphone 10, hence enabling adjustment of the position of the second support point. As an example, the earphone 10 may be for example an earpiece, designed to be mounted such that the transducer 2 is placed near the ear canal when the earphone 10 is mounted in the user's ear. As another example, the earphone 10 may be designed such that the transducer (or housing thereof) is arranged to at least partially enter the ear canal when the earphone 10 is mounted in the user's ear.

The mounting element 11 may be an integral part of the body 3 of the earphone 10 and hence attached to the body 3. Such a mounting element 11 may be attached to the body 3 in a fixed manner so that the direction to which the mounting element 11 extends from the body 3 is fixed. Alternatively, a mounting element 11 forming an integral part of the body 3 may be attached to the body 3 in a moveable manner, thus being arranged to enable adjusting the position of the mounting element 11 with respect to the body 3.

Alternatively, the mounting element 11 may be releaseably attached to the body 3, thereby enabling the mounting element 11 to be attached to the body 3 or to be detached from the body 3 for example by the user. In such an arrangement the mounting element 11 may be attached to the body 3 directly, or the mounting element 11 may be attached to the body 3 via an arm 16 attached to the body 3. In a yet further arrangement the arm 16 may be attached to a body via an angle adjusting element 12. As in the case of the mounting element 11 being an integral part of the body 3 discussed hereinbefore, a mounting element 11 releaseably attached to the body 3 may be attached to the body 3 in a fixed manner or in a moveable manner. An angle adjusting element such as the one illustrated with reference designator 12 can be part of the structure irrespective of whether there is an arm 16 between the mounting element 11 and the body 3 or not.

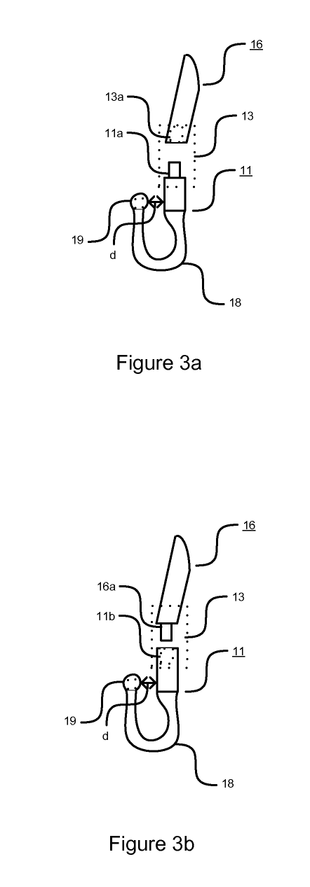

In accordance with an embodiment of the invention, the adjusting element comprises a distance adjustment element 13 for adjusting the distance between the mounting element 11 and the body 3. The distance adjustment element according to an embodiment of the invention is indicated in FIGS. 2a and 2b and illustrated in more detail in a schematic example of FIG. 3a.

The distance adjustment element 13 may comprise an opening 13a and/or a cavity in the body 3 for receiving a portion 11a of the mounting element 11 such that the mounting element is moveable with respect to the body 3, thereby allowing the adjustment of the position of the mounting element 11 with respect to the body 3 and consequently, the adjustment of the position of the second support point. The opening 13a and/or the cavity and the portion 11a may enable the mounting element 11 to be moveable with respect to the body 3 along an axis, such as a linear axis or a curved axis, depending on the shape of the portion 11a and the opening 13a and/or cavity for receiving the portion 11a. Alternatively, as illustrated in the example of FIG. 3a, the opening 13a may be in the arm 16 attached to the body 3. Consequently, the user is able to adjust the position of the mounting element 11 in relation to the body 3 such that the earphone 10 may be adjusted to match the size of the user's ear. Since the corresponding function can be achieved with a variety of openings, cavities, cuttings, and other kinds of voids, both blind and through-going ones, configured to receive the portion 11a, for simplicity we will use the word opening in this description to denote them all.

According to an embodiment of the invention, in order to enable securing or locking the position of the mounting element 11 at a desired distance from the body 3, a surface of the portion 11a of the mounting element 11 arranged to be received in the opening 13a in the body 3 comprises a protrusion. Conversely, an edge or a limiting surface of the opening 13a may comprise a recess or a notch for receiving the protrusion for (temporarily) securing or locking the position of the mounting element 11 with respect to the body 3.

As an example, an opening 13a of a rectangular cross-section and a mounting element 11 having a portion 11a of a rectangular cross-section with a size matching that of the opening 13a may be used. A surface of one of the sides of the portion 11a comprises a protrusion, and the surface of the opening 13a facing this side of the portion 11a comprises one or more recesses, each recess having a size matching that of the protrusion, thereby enabling (temporarily) securing or locking of the position of the mounting element 11 with respect to the body 3 at the distance corresponding to the respective recess.

As a variation of this example, surfaces of two or more of the sides of the portion 11a comprise a protrusion and the respective surfaces of the opening 13a each comprise one or more recesses.

As another variation of the above example, an opening 13a having a circular cross-section and a mounting element 11 comprising a portion 11a having a circular cross-section with a size matching that of the circular opening 13a may be used. A surface of the portion 11a facing the surface of the opening 13a comprises a protrusion, for example an annular protrusion, whereas the surface of the opening 13 facing the surface of the portion 11a comprises one or more recesses having a size and shape matching those of the protrusion, for example one or more annular recesses each having a size matching that of the protrusion.

In a variation of the securing or locking arrangement described hereinbefore, a surface of the opening 13a comprises a protrusion, whereas a surface of the portion 11a of the mounting element 11 arranged to be received in the opening 13a comprises one or more recesses for receiving the protrusion for (temporarily) securing or locking the position of the mounting element 11 with respect to the body 3.

The desired degree of temporary locking can alternatively or additionally be achieved e.g. by selecting the materials and dimensions of the mutually engaging parts so that sufficient amount of friction exists between them.

In accordance with an embodiment of the invention the distance adjustment element 13 may comprise an opening in the mounting element 11 and a portion 16a of an arm 16 extending from the body 3, the opening 11b being arranged to receive the portion 16a such that the mounting element 11 is slideable with respect to the body 3, as illustrated by a schematic example in FIG. 3b. The discussion regarding the protrusion and the one or more recesses is equally applicable also to such an embodiment. Further embodiments of the invention could include two or more pairs of an opening and a matching extending portion, located in various combinations in the parts between which the relative extending and retracting movement is to be achieved. A yet further alternative to enable a controllable extending and retracting movement involves the use of pairwise articulated levers, much like in an articulated jack of miniature size.

Instead of an arrangement of a protrusion and one or more recesses, the distance adjustment element 13 comprising the opening 13a and the portion 11 (or the opening 11b and the portion 16a) may comprise a clamp that may be use to secure or lock the portion 11 (or the portion 16a) in a desired position with respect to the clamp. The clamp may be operatively coupled to a means for releasing and/or securing the clamp, such as a push-button arranged in an exterior surface of the body 13 (or the mounting element 11) such that when the push-button is pressed, the clamp is released thereby allowing a sliding movement of the portion 11a (or the portion 16a) within the opening 13a (or the opening 11b) and with respect to the clamp. Conversely, when the push-button is released, the clamp is secured thereby securing or locking the portion 11a (or the portion 16a) in its current position with respect to the opening 13a (or the opening 11b) and with respect to the clamp. Instead of a push-button, a lever, a switch or another corresponding arrangement operatively coupled to the clamp may be employed as means for releasing and securing the clamp such that in a first position of the lever the clamp is a released position and in a second position of the lever, the switch or another corresponding arrangement.

In a yet further arrangement a screw or a corresponding arrangement may be arranged to extend through a hole in a wall of the opening 13a (or the opening 11b). The hole has a size and a thread matching those of the screw, thus enabling to secure the portion 11a (or the portion 16a) with respect to the opening 13a (or the opening 11b) by tightening the screw and release the portion 11a (or the portion 16a) with respect to the opening 13a (or the opening 11b) by loosening the screw.

As discussed above, the mounting element 11 may be attached to the body 3 via an attachment element. An example of an attachment element is a joint or a corresponding attaching arrangement that enables a rotatable movement of the mounting element 11 with respect to the body 3. The joint may be arranged to enable a rotatable movement about the joint only along a given plane. As an example, a joint may be arranged to enable a rotatable movement along a plane substantially parallel to the surface of the auricle when the earphone 10 is mounted in the user's ear. Such a rotatable movement enables adjustment of the angle in which the mounting element 11 extends from the body 3 and thereby enables adjustment of the position of the mounting element 11 with respect to the body 3. Hence, in such an arrangement the attachment element also acts as an angle adjusting element 12.

As an alternative or in addition to the rotating movement along a plane substantially parallel to the surface of the auricle, the attachment element comprising a joint or a corresponding arrangement and thus acting as an angle adjusting element 12 may be also arranged to enable adjustment of the plane along which the mounting element 11 is rotatable. Such a further rotatable movement enables improved adjustment of the position of the mounting element 11 with respect to the body 3 to provide an even better fit with a user's ear.

In the embodiments of the invention involving the angle adjusting element 12 enabling a rotatable movement discussed hereinbefore, the earphone 10 may further comprise a separate distance adjustment element 11. Also in such an embodiment the distance adjustment element 13 may be arranged to operate as discussed hereinbefore.

The mounting element 11 may comprise or be made of suitable plastics material, such as polycarbonate (PC) or polycarbonate-acrylonitrile butadiene styrene (PC-ABS). While a mounting element 11 comprising or made of PC-ABS provides durable and essentially rigid structure providing a secure mounting of the headphone 10 to the user's ear, a mounting element comprising or made of PC provides some flexibility to the structure of the mounting element 11, thereby facilitating easier mounting of the mounting element 11 to the user's ear while still providing a secure mounting. As a further example, the mounting element 11 may comprise or be made of a suitable light-weight metal, such as aluminum.

The mounting element 11 may comprise a portion that is arranged to enclose a portion of an edge of the auricle, hence providing the second support point for mounting the earphone 10. The portion to be enclosed may be any portion of the edge of the auricle, for example a portion of a helix or a portion of an earlobe. Enclosing a portion of an earlobe may be considered particularly advantageous in that such an arrangement enables secure but yet comfortable fit, thereby by providing a good support for holding the earphone 10 firmly in the user's ear.

In accordance with an embodiment of the invention the mounting element 11 comprises a portion having a U-shaped or essentially U-shaped form, the portion having a U-shaped form having an opening of width d to enable mounting the U-shaped portion to enclose a portion of an edge of the auricle. Instead of being referred to as a U-shaped form, such a form may also be referred to as a J-shaped form, a hook-shaped form, etc. In another words, such a portion defines a bay or cutting at least opening of which has width d, which is of a similar magnitude as the thickness of a human earlobe, for enabling the enclosure of a portion of an edge of the auricle. For simplicity, such a shape is referred to as a U-shaped portion 18 hereinafter.

A first end of the U-shaped portion 18 is coupled to the adjustment element 12, for example to the portion 11a of the mounting element 11 arranged to be received in the opening 13a in the body 3 or in the arm 16 extending from the body 3. The U-shaped portion 18 may be attached directly to the portion 11a or it may be attached to the portion 11a via a further portion of the mounting element 11. When the headphone 10 is mounted in the user's ear, the first end of the U-shaped portion 18 remains in the side of the auricle that is facing away from the user's head. Conversely, a second end of the U-shaped portion 18 will be placed on the inner side of the auricle facing the user's head, so as to enable enclosing a portion of the edge of an auricle.

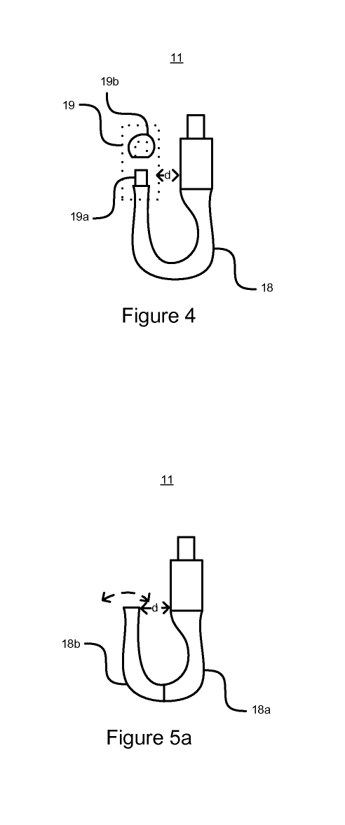

A second end of the U-shaped portion 18, i.e. the free end of the U-shaped portion 18 may comprise a fitting element and/or an arrangement 19a for fixing a replaceable fitting element 19b, thereby constituting a fit adjusting element for adjusting the strength of the contact between the mounting element 11 and the auricle. Such an arrangement is illustrated by a schematic example in FIG. 4. The arrangement 19a may comprise for example a protrusion to which a replaceable fitting element 19b provided with a corresponding opening may be releaseably fixed by press-fit. As another example, the arrangement 19a may comprise a thread and the replaceable fitting element 19b may comprise a matching counter-thread to enable releasable fixing of the fitting element 19b. Replaceable fitting elements 19b of different size, material, surface, texture and/or softness may be provided in order to enable setting a suitable width of the opening d and suitable friction between the mounting element 11 and the auricle, thereby contributing to the fit of the mounting element 11 to auricles of different size and thickness. Alternatively or additionally, the U-shaped portion 18 as a whole may be replaceable and hence releaseably attached to the mounting element 11 to enable attachment of a U-shaped portion 18 providing a suitable width of the opening d and/or suitable selection of the other variable characteristics, hence acting as a fit adjusting element for adjusting the strength of the contact between the mounting element 11 and the auricle.

For users with one or more piercings in their auricle, a fitting element may be provided that is configured to go partly or all the way through the pierced hole. In some embodiments of the invention such a fitting element might make even the U-shaped portion unnecessary, so that the fitting element for pierced auricles could be attached directly to that portion of the mounting element 11 that in the figures extends downwards from the distance adjusting element 13. The places in the auricle where people have piercings vary considerably, which underlines the advantages that can be obtained by having the distance adjusting element 13 as a part of the structure.

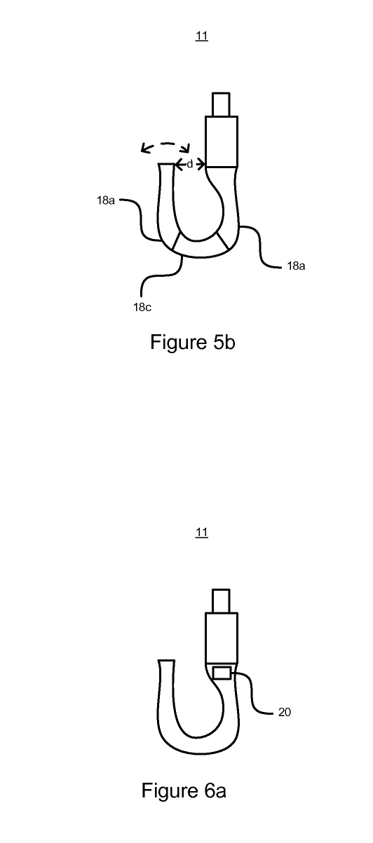

In accordance with an embodiment of the invention, the mounting element 11 may comprise a deformable portion 18b that can be press-fitted to enclose portion of an edge of the auricle to provide the second support point for mounting the earphone 10. The mounting element 11 may be deformable as a whole or only part of the mounting element 11 may be arranged to be deformable. As an example, assuming a first end of the mounting element 11 being attachable to the body 3 of the headphone 10, a selected sub-portion 18b in the second end of the mounting element 11 may be deformable, whereas the rest of the mounting element 11, i.e. the portion 18a, may be rigid or essential rigid (see FIG. 5a for a schematic example of such an arrangement). As another example (see FIG. 5b for a schematic example), selected sub-portions 18a in both the first end and the second end of the mounting element 11 may be rigid or essentially rigid, whereas a third sub-portion 18c between the rigid or essentially rigid portions in the first and second ends is deformable.

A deformable portion of the mounting element 11 as described hereinbefore may act as part of the adjusting element, for example as the distance adjustment element 13 (or a part thereof) and/or as the fit adjusting element.

As an example, a deformable portion 18b of the mounting element 11 may comprise a strip of deformable metallic sheet material, such as aluminum or copper. The strip of deformable metallic sheet material may be covered at least in part by a layer of flexible plastics material, such as suitable thermoplastic elastomer (TPE), sometimes also referred to as thermoplastic rubber (TPR). Further examples of material suited for covering the deformable portion include for example rubber, silicone and/or other flexible and durable materials. Such a deformable portion 18b, 18c is arranged to be flexible such that it enables shaping of the deformable portion 18b to form a curved shape, for example into a U-shaped form having a desired width d of the opening as described hereinbefore so as to enclose a portion of an edge of the auricle with a desired fit.

In accordance with an embodiment of the invention, the mounting element 11 comprises one or more sensors for measuring momentary characteristics of human tissue in order to enable determining one or more physiological parameters of the user wearing the headphone 10. Such a sensor may be arranged to measure characteristics such as a voltage on the surface of the skin, skin temperature, a flow of blood through a blood vessel in the tissue to enable estimation of physiological parameters such as heart rate, oxidation of blood, body temperature, etc. The one or more sensors may be arranged to measure one or more different characteristics of human tissue. The adjusting element that enables adjusting the position of the mounting element 11 with respect to the body 3 of the earphone 10, consequently, enables adjusting the position of a sensor to a position providing a reliable measurement of characteristics enabling estimation of the desired physiological parameter.

A power supply to the one or more sensors of the mounting element 11 may be arranged for example via the adjusting element. The body 3 of the earphone 10 may comprise a battery that may be used to supply operating power to the one or more sensors via the adjusting element. Alternatively or additionally, the body of the earphone may comprise means for receiving power for example from a separate processing unit coupled to the body 3 e.g. via one or more wires and means for using making use of the received power to supply operating power to the one or more sensors via the adjusting element. A further possibility to supply operating power to the one or more sensors in the mounting element 11 the body 3 may comprise means for providing inductive energy, whereas the mounting element 11 may comprise means for receiving the inductive energy and using the received inductive energy for supplying operating power to the one or more sensors.

As an example, according to an embodiment of the invention, the mounting element 11 comprises a sensor for measuring a flow of blood in a blood vessel within the auricle in order to enable e.g. estimation of the heart rate. The sensor comprises a transmitter unit 20a arranged to send a first measurement signal and a receiver unit 20b arranged to receive a second measurement signal. The transmitter unit 20a and the receiver unit 20b may be arranged to transmit and receive, respectively, for example infrared (IR) signals. The second measurement signal is a modified version of the first measurement signal characteristics of which are affected, i.e. modified, by the flow of blood through a blood vessel in the auricle in the path of the first measurement signal. When the earphone 10 comprising the mounting element 10 provided with the sensor is mounted in the user's ear, the sensor is in contact with the auricle, thereby enabling the transmitter unit 20a to transmit the first measurement signal such that it will be received by the receiver unit 20b as the second measurement signal, i.e. as the first signal modified .e.g. by the flow of blood in a blood vessel within the auricle.

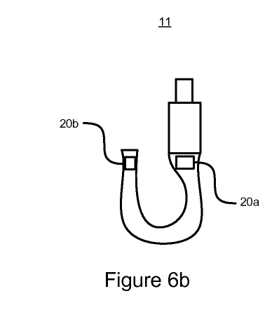

The transmitter unit 20a and the receiver unit 20b may be arranged in the mounting element 11 such that they are placed in the same side of the auricle when the earphone 10 is mounted in the ear of the user, as illustrated in the schematic example of FIG. 6a. For example in case the mounting element comprises the U-shaped portion 18, the transmitter unit 20a and the receiver unit 20b are arranged in the same “arm” of the U-shaped portion 18, thereby being arranged to be placed in the same side of the auricle when the earphone 10 is mounted in the ear of the user. Typically, this “arm” of the U-shaped portion 18 is the first end of the U-shaped portion attachable to the body 3. In such an arrangement the receiver unit 20b is arranged to receive the second measurement signal as the reflected version of the first measurement signal, reflected by the flow of blood in a vessel within the auricle. Consequently, the second measurement signal has modified characteristics compared to those of the first measurement signal, enabling e.g. the analysis of the heart rate based on the two measurement signals.

In an alternative arrangement, the transmitter unit 20a and the receiver unit 20b are arranged in the mounting element 11 such that they are placed in the opposite sides of the auricle when the earphone 10 is mounted in the ear of the user, as illustrated in the schematic example of FIG. 6b. For example in case the mounting element comprises the U-shaped portion 18, the transmitter unit 20a and the receiver unit 20b are arranged in the different “arms” of the U-shaped portion 18, thereby being arranged to be placed in the opposite sides of the auricle when the earphone 10 is mounted in the ear of the user. In such an arrangement the receiver unit 20b is arranged to receive the second measurement signal as the deflected or otherwise distorted version of the first measurement signal, deflected or otherwise distorted by the flow of blood in a blood vessel within the auricle. Consequently, the second measurement signal has modified characteristics compared to those of the first measurement signal, enabling the analysis and estimation of a physiological parameter such as the heart rate based on the two measurement signals. In a variation of the arrangement described above, both earphones 10 of a pair of earphones may comprise a transmitter unit 20a and a receiver unit 20b, thereby enabling improved accuracy and reliability of estimation of a physiological parameter such as heart rate based on measurement signals from the two ears.

The control unit 6 is arranged to access the characteristics of the first and second measurement signals in order to enable the analysis of the heart rate. The control unit 6 may be arranged to process the first and second measurement signals and to control the transducer 2 to reproduce an audible response to the user indicating the measured or estimated value of a physiological parameter, such as the current heart rate. As an example, the audible response may comprise a periodic sound having a period corresponding to the measured current heart rate. Alternatively or additionally, the response may include an audio prompt generated in response to comparing the measured or estimated value of a physiological parameter to a predetermined threshold.

Instead of the control unit processing the characteristics of the first and second measurement signals, the control unit 6 may be arranged to provide the characteristics to a separate processing unit coupled to the headphone 10, as described hereinafter. In such an arrangement the analysis of the current heart rate may be performed by the processing unit, and the control unit 6 may be arranged to receive the outcome of the analysis and to control the transducer 2 to produce an audible response to the user as described hereinbefore.

As another example of a sensor for measuring momentary characteristics of human tissue for estimating a physiological parameter, the mounting element 11 may comprise a sensor for measuring a voltage (or potential) on the surface of the auricle at least on two positions separate from each other. In particular, in an arrangement of a pair of earphones, each earphone 10 may comprise a sensor for measuring a voltage (or potential) on the surface of the auricle. The measured voltage values may be provided for analysis to the control unit 6 in one of the earphones 10 or to a (separate) processing unit, as described above in context of the example providing a sensor for measuring the heart rate using IR signals.

The earphone 10 may be coupled to the separate processing unit for example by one or more wires enabling exchange of signals between the earphone 10 and the processing unit, the exchange of signals controlled by the control unit 6, possibly in co-operation with a further control unit comprised in the processing unit. Alternatively or additionally, the earphone may be coupled to the processing unit by a wireless connection, such as Bluetooth, a wireless local area network (WLAN), a WiFi link, etc. The processing unit may be arranged to provide the audio input signal to the earphone 10, to receive information signals from the earphone 10, to process the information signals received from the earphone 10, and to provide information signals to the earphone 10 in response to the processing.

The earphone 10 may be coupled to another earphone to enable reproduction of two-channel (stereophonic) audio signals to a user. The two earphones may be coupled to each other for example by one or more wires or by a wireless connection to enable exchange of signals between the two earphones, controlled by the control unit 6, possibly in co-operation with a further control unit comprised in the processing unit. Both of the two earphones 10 may be coupled to the processing unit as described hereinbefore, or only one of the earphones 10 may be coupled to the processing unit.

The processing unit may be further coupled to a mobile device, such as an audio player or a mobile phone, for example by one or more wires or by a wireless connection to enable exchange of signals between the processing unit and the mobile device. The mobile device may comprise a processor and a memory arranged to run software that enables communication with the processing unit. The mobile device may be arranged control the operation of the processing unit and, consequently, the operation of the earphone 10.

In particular, the mobile device may be arranged to provide the audio input signal to the processing unit, to receive information signals from the processing unit, to process the information signals received from the processing unit, and to provide information signals to the processing unit in response to the processing.

1-20. (canceled)

21. An earphone comprising
a mounting element for mounting the earphone to an auricle, the mounting element being attachable to a body of the earphone, and
an adjusting element for adjusting the position of the mounting element with respect to the body of the earphone.

22. The earphone according to claim 21, wherein the adjusting element comprises a distance adjustment element for adjusting the distance between the mounting element and the body.

23. The earphone according to claim 22, wherein the distance adjustment element comprises an opening in the body for receiving a portion of the mounting element such that the mounting element is moveable with respect to the body.

24. The earphone according to claim 23, wherein a surface of the portion within the opening comprises a protrusion, and wherein a surface of the opening comprises a recess for receiving the protrusion for securing the position of the mounting element with respect to the body.

25. The earphone according to claim 23, wherein a surface of the opening comprises a protrusion, and wherein a surface of the portion of the mounting element within the opening comprises a recess for receiving the protrusion for securing the position of the mounting element with respect to the body.

26. The earphone according to claim 21, wherein the mounting element comprises a fit adjusting element for adjusting the contact between the mounting element and the auricle

27. The earphone according to claim 21, wherein the mounting element comprises a U-shaped portion arranged to enclose a portion of an edge of the auricle.

28. The earphone according to claim 27, wherein the U-shaped portion defines a bay at least opening of which has width of a similar magnitude as the thickness of a human earlobe.

29. The earphone according to claim 27, wherein a free end of the U-shaped portion comprises an arrangement for fixing a replaceable fitting element.

30. The earphone according to claim 26, wherein the mounting element comprises a deformable portion that can be press-fitted to enclose portion of an edge of the auricle.

31. The earphone according to claim 21, wherein the mounting element comprises a sensor for measuring characteristic of human tissue for determining one or more physiological parameters.

32. The earphone according to claim 31, wherein the sensor comprises an infrared transmitting unit and an infrared receiver unit for measuring heart rate.

33. A mounting element for mounting the earphone to an auricle, the mounting element being attachable to a body of an earphone and comprising an adjusting element for adjusting the position of the mounting element with respect to the body of the earphone.

34. The mounting element according to claim 33, wherein the adjusting element comprises a distance adjustment element for adjusting the distance between the mounting element and the body.

35. The mounting element according to claim 34, wherein the distance adjustment element comprises a portion of the mounting element arranged to be received by an opening of a body of the earphone such that the mounting element is slideable with respect to the body.

36. The mounting element to claim 35, wherein a surface of the portion comprises a protrusion arranged to be received by a recess in a surface of the opening for securing the position of the mounting element with respect to the body.

37. The mounting element according to claim 35, wherein a surface of the portion comprises a recess for receiving a protrusion arranged in a surface of the opening for securing the position of the mounting element with respect to the body.

38. The mounting element according to claim 33, comprising a U-shaped portion arranged to enclose a portion of an edge of the auricle.

39. The mounting element according to claim 33, comprising a sensor for measuring characteristic of human tissue for determining one or more physiological parameters.

40. An earphone body arranged to receive a mounting element according to claim 33.
